(19) United States
(12) Patent Application Publication
(10) Pub. No.: US 2010/0126324 A1
(43) Pub. Date: May 27, 2010

(54) Quickly detachable spreader mounting structure for table saw

(75) Inventors: Chia-Sheng Liu, Taichung County (TW); Chieh-Yuan Tsai, Taichung County (TW)

Correspondence Address: BACON & THOMAS, PLLC, 625 SLATERS LANE, FOURTH FLOOR, ALEXANDRIA, VA, 22314-1176, US

(73) Assignee: DURQ MACHINERY CORP., TAICHUNG (TW)

(21) Appl. No.: 12/318,890

(22) Filed: Jan. 12, 2009

(30) Foreign Application Priority Data
Nov. 21, 2008 (TW) 97145274

(51) Int. Cl. B26D 7/00

(52) U.S. Cl. 83/438

(57) ABSTRACT

A quickly detachable spreader mounting structure used in a table saw is disclosed to include a spreader holder, a spreader detachably clamped in the spreader holder, a positioning member inserted through the spreader holder and the spreader and having a positioning portion, and a handle coupled to the positioning member and having a protruding portion and biasable between an unlocking position where the protruding portion is moved away from the positioning portion to release the spreader from the spreader holder and a locking position where the protruding portion is abutted against the positioning portion to lock the spreader to the spreader holder.

### BACKGROUND OF THE INVENTION

1. Field of the Invention

The present invention relates to table saws and more specifically, to a quickly detachable spreader mounting structure for table saw, which allows quick mounting/dismounting of the spreader.

2. Description of the Related Art

When a workpiece is placed on the table and pushed toward the saw blade for cutting by the saw blade, the cut part of the workpiece may impart a clamping force to the saw blade subject to the applied push force and the material return spring power of the workpiece itself, enhancing friction between the workpiece and the saw blade and hindering feeding of the workpiece. To avoid this problem, a table saw is usually equipped with a spreader for cutting into the cut gap in the workpiece being cut by the saw blade to stretch open the cut part of the workpiece, facilitating cutting operation and workpiece feeding and assuring cutting safety.

Further, the saw blade of the table saw is vertically adjustable to facilitate cutting of different workpieces. Further, the spreader of the table saw is made detachable to facilitate installation. It is always the way people in the sawing machine industry to design a table saw that facilitates quick mounting and dismounting of the spreader.

### SUMMARY OF THE INVENTION

The present invention has been accomplished under the circumstances in view. It is the main object of the present invention to provide a quickly detachable spreader mounting structure for table saw, which allows quick mounting and dismounting of the spreader.

To achieve this and other objects of the present invention, a quickly detachable spreader mounting structure for table saw comprises a spreader holder, which comprises two clamping plates each having a through hole, a spreader, which is set in between the two clamping plates and comprises a sliding slot kept in alignment between the through holes of the clamping plates, a positioning member, which is inserted through the through holes of the clamping plates and the sliding slot of the spreader and comprises a head disposed outside the spreader holder and a positioning portion perpendicularly radially protruded from the periphery of the head, a handle, which is coupled to the positioning member and movable along the positioning member and biasable relative to the spreader between a locking position and an unlocking position and comprises a protruding portion, which is abutted against the positioning portion of the positioning member such that the handle is moved along the positioning member to push one clamping plate and the spreader toward the other clamping plate when the handle is in the locking position and which is disengaged from the positioning portion of the positioning member such that the handle is released from the clamping plates when the handle is in the unlocking position, and a first spring member stopped between the head of the positioning member and the handle and adapted to push the handle apart from the clamping plates when the handle is in the unlocking position.

### BRIEF DESCRIPTION OF THE DRAWINGS

FIG. 1 is an elevational assembly view of a quickly detachable spreader mounting structure for table saw in accordance with the present invention.

FIG. 2 is an exploded view of the quickly detachable spreader mounting structure in accordance with the present invention.

FIG. 3 is a sectional side view of a part of the present invention, showing the handle in the locking position.

FIG. 4 is a sectional view of FIG. 3, showing the protruding portions of the handle forced into engagement with the positioning portions of the positioning member.

FIG. 5 is another sectional side view of a part of the present invention, showing the handle in the locking position.

FIG. 6 is a sectional view of FIG. 5, showing the positioning portions of the positioning member received in the recessed portions of the handle.

FIG. 7 is a side view of the present invention, showing the positioning rods of the fixed clamping plate engaged into the third positioning holes of the spreader.

### DETAILED DESCRIPTION OF THE INVENTION

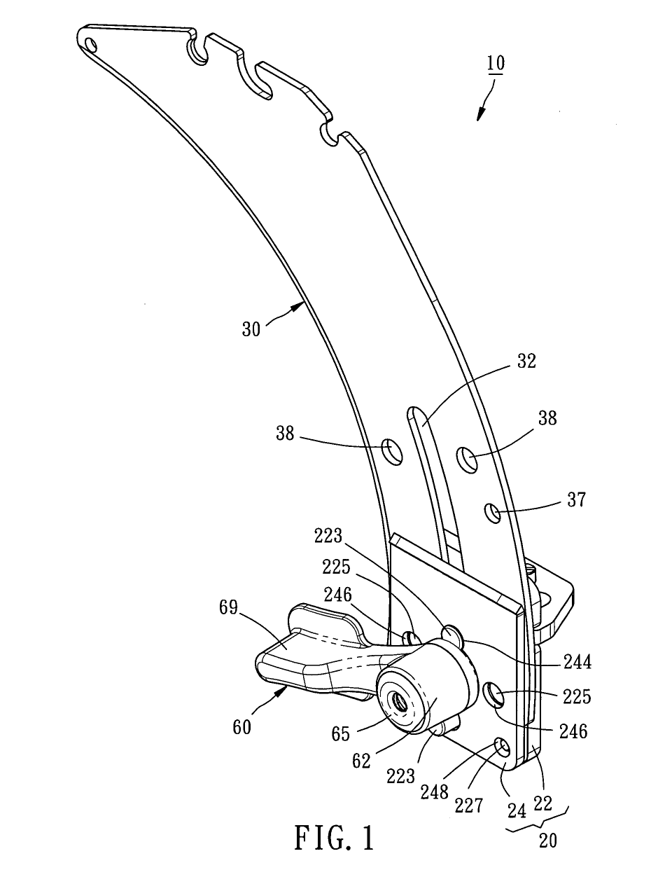

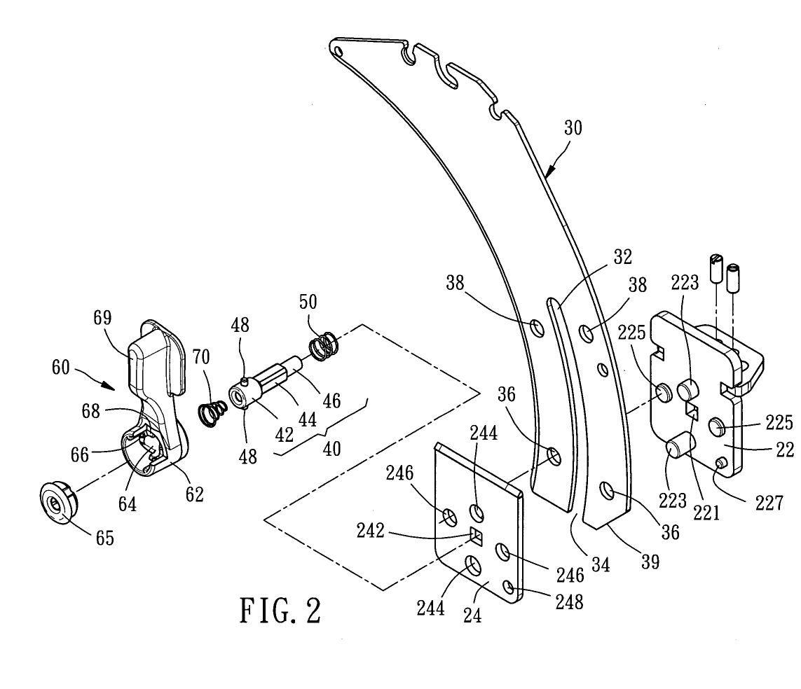

Referring to FIGS. 1 and 2, a quickly detachable spreader mounting structure 10 in accordance with the present invention is shown comprising a spreader holder 20, a spreader 30, a positioning member 40, a second spring member 50, a handle 60 and a first spring member 70.

The spreader holder 20 comprises a fixed clamping plate 22 and a movable clamping plate 24. The fixed clamping plate 22 has a rectangular first through hole 221 at the center, two connection rods 223 perpendicularly extended from its one side and respectively disposed at the top and bottom sides relative to the first through hole 221, two chamfered positioning rods 225 perpendicularly extended from the same side and respectively disposed at the left and right sides relative to the first through hole 221, and a locating rod 227 perpendicularly extended from the same side in the lower right corner. The movable clamping plate 24 has a rectangular second through hole 242 corresponding to the rectangular first through hole 221 of the fixed clamping plate 22, two connection holes 244 respectively disposed at the top and bottom sides relative to the rectangular second through hole 242 for receiving the connection rods 223 of the fixed clamping plate 22 respectively, two first positioning holes 246 respectively disposed at the left and right sides relative to the rectangular second through hole 242 for receiving the positioning rods 225 of the fixed clamping plate 22, and a locating hole 24 disposed in the lower right corner for receiving the locating rod 227 of the fixed clamping plate 22.

The spreader 30 has a sliding slot 32 longitudinally extending to the bottom side and terminating in an opening 34 through which the connection rods 223 of the fixed clamping plate 22 is inserted into the sliding slot 32 of the spreader 30 to have the spreader 30 set in between the fixed clamping plate 22 and the movable clamping plate 24 without biasing, two second positioning holes 36 disposed near the bottom end of the sliding slot 30 and at two opposite lateral sides relative to the sliding slot 32, two third positioning holes 38 disposed near the top end of the sliding slot 30 and at two opposite lateral sides relative to the sliding slot 32, and a beveled stop edge 39 disposed at the right bottom side. The two second positioning holes 36 and the two third positioning holes 38 are adapted to selectively receive the positioning rods 225 of the fixed clamping plate 22 to let the spreader 30 be selectively positioned in two different elevations.

The positioning member 40 is a stepped rod member having a head 42 of circular cross section, an endpiece 46 of circular cross section, a shank 44 of rectangular cross section connected between the head 42 and the endpiece 46. As shown in FIG. 4, the shank 44 and the endpiece 46 are inserted through the rectangular second through hole 242 of the movable clamping plate 24, the sliding slot 32 of the spreader 30 and the rectangular first through hole 221 of the fixed clamping plate 22. By means of engagement between the rectangular shank 44 and the rectangular first through hole 221 of the fixed clamping plate 22 and the rectangular second through hole 242 of the movable clamping plate 24, the positioning member 40 is prohibited from rotation relative to the spreader holder 20 and the spreader 30. The positioning member 40 further has two positioning portions 48 radially extending out of the head 42 at two opposite sides. According to this embodiment, a pin is transversely inserted through the head 42 of the positioning member 40, thereby forming the two positioning portions 48.

The second spring member 50 is sleeved onto the shank 44 of the positioning member 40 and stopped between the head 42 of the positioning member 40 and the movable clamping plate 24 to impart a pressure to the movable clamping plate 24 toward the spreader 30.

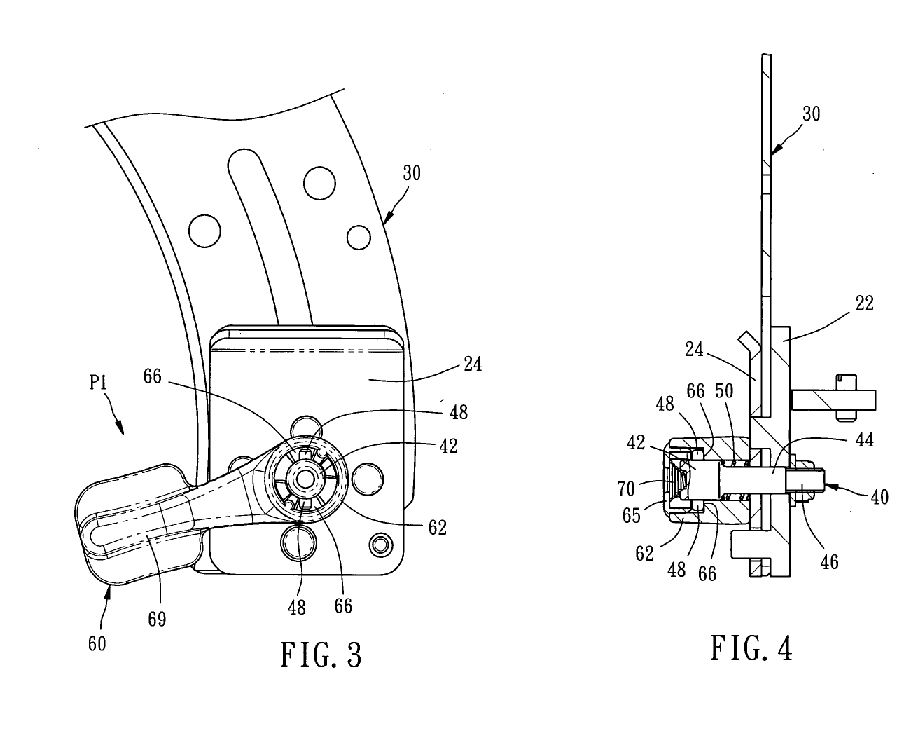

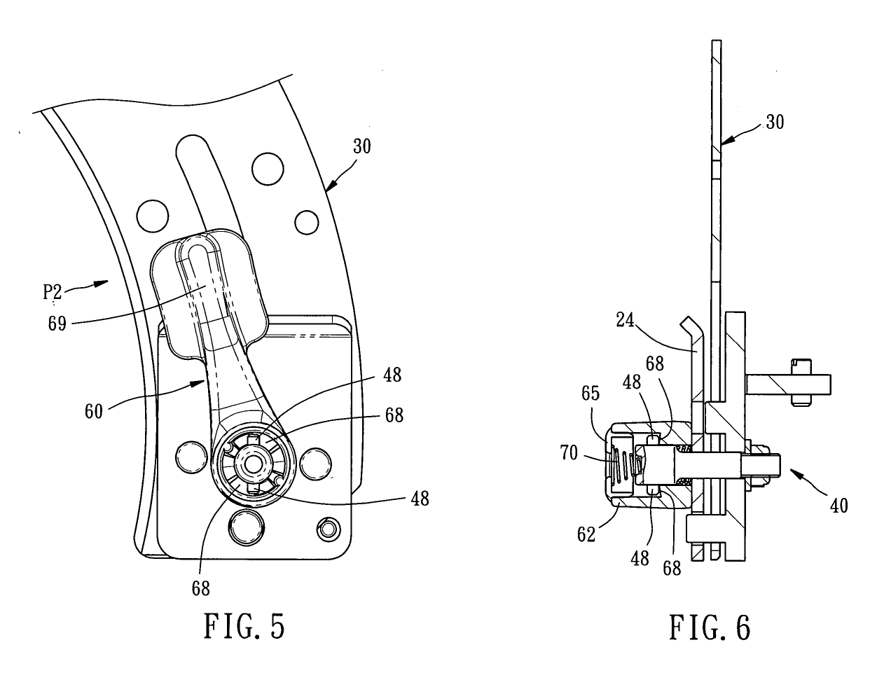

The handle 60 has a coupling unit 62 and a grip 69. The coupling unit 62 includes a coupling hole 64 coupled to the head 42 of the positioning member 40 so that a user can operate the grip 69 to bias the handle 60 between a locking position P1 shown in FIG. 3 and an unlocking position P2 shown in FIG. 5. The handle 60 further has a plurality of protruding portions 66 and recessed portions 68 alternatively arranged around the coupling hole 64 to provide a cam effect. When the handle 60 is in the locking position P1 shown in FIGS. 3 and 4, the protruding portions 66 are abutted against the positioning portions 48 of the positioning member 40 to prohibit rotation of the handle 60 relative to the spreader 30, enabling the handle 60 to be moved axially along the positioning member 40 toward the movable clamping plate 24 to push the movable clamping plate 24 toward the fixed clamping plate 22 and to have the spreader 30 be firmly secured between the movable clamping plate 24 and the fixed clamping plate 22. When the handle 60 is in the unlocking position P2 shown in FIGS. 5 and 6, the protruding portions 66 are disengaged from the positioning portions 48 of the positioning member 40, and the recessed portions 68 are shifted to the positioning portions 48 of the positioning member 40. At this time, the second spring member 70 that is received in the coupling unit 62 of the handle 60 and stopped the head 42 of the positioning member 40 and a cap 65 that is fastened to the coupling unit 62 of the handle 60 impart a pressure to push the handle 60 away from the movable clamping plate 24, thereby unlocking the spreader 30.

The mounting and dismounting operations of the spreader 30 are described hereinafter.

When mounting the spreader 30, make sure that the handle 60 is in the unlocking position P2, and then insert the bottom end of the spreader 30 into the gap between the fixed clamping plate 22 and the movable clamping plate 24 to aim the opening 34 of the spreader 30 at the connection rods 223 of the fixed clamping plate 22, and then lower the spreader 30 to force the movable clamping plate 24 apart from the fixed clamping plate 22 to the position where the first positioning holes 246 of the movable clamping plate 24 are respectively disengaged from the positioning rods 225 of the fixed clamping plate 22. When the beveled stop edge 39 of the spreader 30 touches the locating rod 227 of the fixed clamping plate 22, the positioning rods 225 of the fixed clamping plate 22 are respectively forced into the second positioning holes 36 of the spreader 30. Thereafter, bias the handle 40 to the locking position P1 shown in FIGS. 3 and 4 to force the protruding portions 66 into engagement with the positioning portions 48 of the positioning member 40 and to further force the movable clamping plate 24 against the spreader 30 toward the fixed clamping plate 22, thereby locking the spreader 30 in position.

On the contrary, when wishing to dismount the spreader 30, bias the spreader 60 to the unlocking position P2 shown in FIGS. 5 and 6 to release the second spring member 70, enabling the second spring member 70 to push the cap 65 and the handle 60 apart from the movable clamping plate 24. At this time, the handle 60 is prohibited from vibration, and the user can pull the spreader 30 directly away from the spreader holder 20.

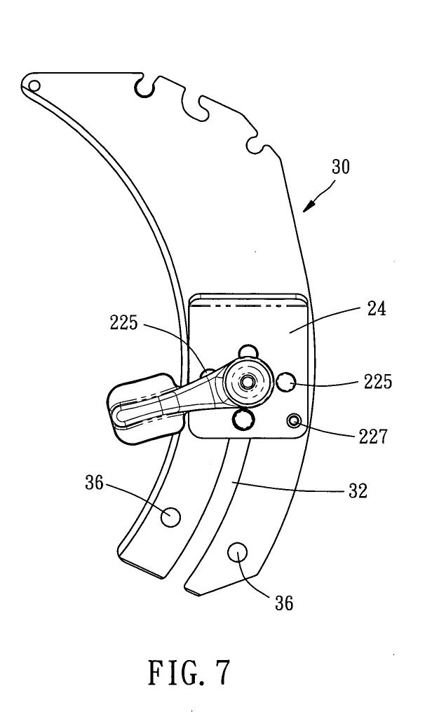

When the second positioning holes 36 of the spreader 30 are respectively coupled to the positioning rods 225 of the fixed clamping plate 22, the spreader 30 is set for a relatively thicker workpiece cutting operation, and an eye-protection guard can be mounted on the top side of the spreader 30. When an eye-protection guard is not used, the third positioning holes 38 of the spreader 30 are respectively coupled to the positioning rods 225 of the movable clamping plate 22, and the locating rod 227 of the movable clamping plate 22 is engaged into a locating hole 37 on the spreader 30 (see FIG. 7). At this time, the spreader 30 is set for a relatively thinner workpiece cutting operation.

Thus, by means of the cam design of the protruding portions and recessed portions of the handle, the spreader can be conveniently and rapidly mounted in or detached from the spreader holder.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A quickly detachable spreader mounting structure comprising:
a spreader holder, said spreader holder comprising two clamping plates, each said clamping plate comprising a through hole;
a spreader set in between said two clamping plates, said spreader comprising a sliding slot kept in alignment between the through holes of said clamping plates;
a positioning member inserted through the through holes of said clamping plates and the sliding slot of said spreader, said positioning member comprising a head disposed outside said spreader holder and a positioning portion perpendicularly radially protruded from the periphery of said head;
a handle coupled to said positioning member and movable along said positioning member and biasable relative to said spreader between a locking position and an unlocking position, said handle comprising a protruding portion, said protruding portion of said handle being abutted against the positioning portion of said positioning member such that said handle is moved along said positioning member to push one said clamping plate and said spreader toward the other said clamping plate when said handle is in said locking position, said protruding portion of said handle being disengaged from the positioning portion of said positioning member such that said handle is released from said clamping plates when said handle is in said unlocking position; and
a first spring member stopped between said head of said positioning member and said handle and adapted to push said handle apart from said clamping plates when said handle is in said unlocking position.

2. The quickly detachable spreader mounting structure as claimed in claim 1, wherein said handle further comprises a recessed portion disposed at one side of said protruding portion of said handle, said recessed portion being kept away from the positioning portion of said positioning member when said handle is in said locking position, said recessed portion receiving the positioning portion of said positioning member when said handle is in said unlocking position.

3. The quickly detachable spreader mounting structure as claimed in claim 1, wherein said positioning member comprises a pin transversely inserted through said head, said pin having a part extending out of said head to form said positioning portion.

4. The quickly detachable spreader mounting structure as claimed in claim 1, further comprising a second spring member sleeved onto a shank of said positioning member and stopped between the head of said positioning member and one said clamping plate to force the respective clamping plate against said spreader.

5. The quickly detachable spreader mounting structure as claimed in claim 1, wherein said shank of said positioning member has a rectangular cross section, the through holes of said clamping plates are rectangular through holes that receive said shank of said positioning member to prohibit rotation of said positioning member relative to said spreader.

6. The quickly detachable spreader mounting structure as claimed in claim 1, wherein one said clamping plate of said spreader holder comprises a connection hole, and the other said clamping plate of said spreader holder comprises a connection rod that is inserted through said sliding slot of said spreader and fitted into the connection hole of said clamping plate.

7. The quickly detachable spreader mounting structure as claimed in claim 1, wherein a first one of said clamping plates of said spreader holder comprises a first positioning hole; said spreader comprises a second positioning hole disposed near a bottom end of said sliding slot and a third positioning hole disposed near a top end of said sliding slot; a second one of said clamping plates of said spreader holder comprises a positioning rod that is selectively inserted through one of the second positioning hole and third positioning hole of said spreader and fitted into the first positioning hole of the first one of said clamping plates of said spreader holder.

8. The quickly detachable spreader mounting structure as claimed in claim 7, wherein the first one of said clamping plates of said spreader holder comprises a locating rod and the second one of said clamping plates of said spreader holder comprises a locating hole; said spreader comprises a beveled bottom edge, which is stopped against said locating rod when said positioning rod of the second one of said clamping plates is inserted through the second positioning hole of said spreader.
